(19) United States
(12) Patent Application Publication
(10) Pub. No.: US 2009/0193084 A1
(43) Pub. Date: Jul. 30, 2009

(54) Method and apparatus for obtaining information from a plurality of network elements

(76) Inventor: Mounire El Houmaidi, Orlando, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/631,050

(22) PCT Filed: Jun. 28, 2005
(86) PCT No.: PCT/EP2005/053015

§ 371 Date: Dec. 28, 2006

Related U.S. Application Data
(60) Provisional application No. 60/584,355, filed on Jun. 30, 2004.

(51) Int. Cl. G06F 15/82

(52) U.S. Cl. 709/206

(57) ABSTRACT

In one aspect, a method for obtaining information from a plurality of network elements via a management system is provided. According to one embodiment, a plurality of network elements join a broadcast group associated with a broadcast channel. A management request message is broadcasted to the group and is processed by each of the elements in the broadcast group. The network elements add the processed information to a response message in turn. When the response message reaches a threshold or no all the elements have added the processed information the response message is sent to the management system. If some elements have not added the processed information, a new response message is formed so that plurality of network elements that have not added the processed information may add the information.

### CROSS-REFERENCE TO RELATED APPLICATIONS

The present application claims the benefit of the provisional patent application filed on Jun. 30, 2004, and assigned application No. 60/584,355.

### FIELD OF THE INVENTION

The present invention relates to a method and apparatus for obtaining information from a plurality of network elements in a communications network, and more particularly, to a method and apparatus for a modified Simple Network Management Protocol network to obtain the information of a plurality of network elements via a single request from a management system.

### BACKGROUND

A communication network commonly uses a management system, e.g. an Element Management System (EMS), to manage network elements such as a Media Gateway (MG), Optical Line Terminal (OLT), or Digital Subscriber Line Access Multiplexer (DSLAM) that are associated to the network. Network element management includes requests for performance monitoring, audits, inventory checks, and miscellaneous maintenance functions. These requests may be repetitive and/or periodic, such as requesting an audit every 15 minutes, as well as automatic and/or manual. For each request the EMS sends a message based on a protocol, for example Simple Network Management Protocol (SNMP) to a single network element. The single network element sends a response message for the request A shortcoming of this one-to-one messaging scheme is the increased overhead on the throughput of messages to the EMS. Therefore, there exists a need to provide an improved way to manage network elements by an EMS.

### SUMMARY OF THE INVENTION

In one aspect of the invention, a network element managed by a management system comprises a join mechanism for joining the network element to a broadcast group, a first receiver receiving a management request from the management system via the broadcast group, a result buffer storing a result of the management request message, a second receiver receiving a management response message from a previous network element, and a sender sending an updated management response message to an entity selected from the group consisting of the management system and a subsequent network element.

In another aspect of the invention, a method for managing a plurality of network elements via a management system comprises joining a first, a second, and a third network element to a broadcast group associated with a broadcast channel, sending a management request message from the management system, broadcasting the management request message to the elements in the broadcast group, processing the management request message by the first, second, and third network elements, and sending a management response message from the first network element to the second network element.

In another aspect of the invention, a Simple Network Management Protocol (SNMP) request message adapted to manage a plurality of network elements is provided. The SNMP request message comprises a SNMP request header, and for a plurality of network elements, each of the plurality of network elements has a request specific to a network element.

In still another aspect of the invention, a SNMP response message adapted to provide information from a plurality of network elements is provided. The SNMP response message comprises a SNMP request header, and a plurality of result fields, each of the plurality of result fields has a result specific to a network element.

### BRIEF DESCRIPTION OF THE DRAWINGS

The above mentioned and other concepts of the present invention will now be described with reference to the drawings of the exemplary and preferred embodiments of the present invention. The illustrated embodiments are intended to illustrate, but not to limit the invention. The drawings contain the following figures, in which like numbers refer to like parts throughout the description and drawings wherein:

FIG. 1 illustrates an exemplary prior art schematic diagram of a communications system having a management system using a one-to-one messaging scheme;

FIG. 2 illustrates an embodiment of an exemplary schematic diagram of the present invention for managing the network elements using a one-to-many messaging scheme;

FIG. 3 illustrates another embodiment of an exemplary schematic diagram of the present invention for managing the network elements using a one-to-many messaging scheme;

FIG. 4 illustrates another embodiment of an exemplary schematic diagram of the present invention for managing the network elements having multiple responses.

FIG. 5 illustrates an exemplary message layout of a Simple Network Management Protocol (SNMP) request message of the present invention; and

FIG. 6 illustrates an exemplary message layout of a SNMP response message of the present invention.

### DETAILED DESCRIPTION OF THE INVENTION

The invention described herein may employ one or more of the following concepts. For example, one concept relates to broadcasting a management request to a plurality of network elements. Another concept relates to a modified an Element Management System (EMS). Another concept relates to a modified a network element. Another concept relates to a modified a Simple Network Management Protocol (SNMP) request message. Yet another concept relates to a modified an SNMP response message.

The present invention is disclosed in context of use of a communications network managed by an EMS using SNMP and Internet Group Management Protocol (IGMP). The principles of the present invention, however, are not limited to use within an EMS but may be applied to other management systems such as a network management system. Also, while management request messages are described as SNMP request messages and management response messages are described as SNMP response messages other network management protocols such as Transaction Management 1 (TL1), and Common Management Information Protocol (CMIP) may be used. Additionally, multicast related protocols other than IGMP may be used. One skilled in the art may find additional application for the apparatus, processes, systems, components, configurations, methods and applications disclosed herein. Thus, the illustration and description of the present invention in context of a communications network managed by an EMS using SNMP and IGMP is merely one possible application of the present invention. However, the present invention has particular applicability for use as a communications network managed by an EMS using SNMP and IGMP.

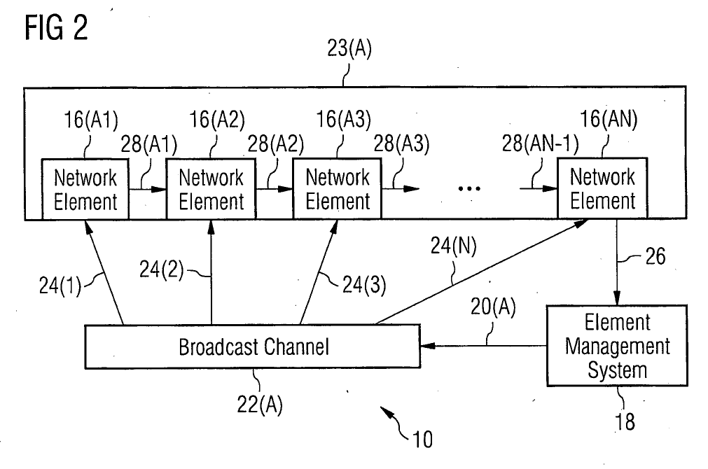

Referring to FIG. 2, an exemplary schematic diagram of a method and apparatus is provided. The EMS transmits an SNMP request to network elements 16 via a broadcast group 16. The network elements 16 communicate between each other using a communication order.

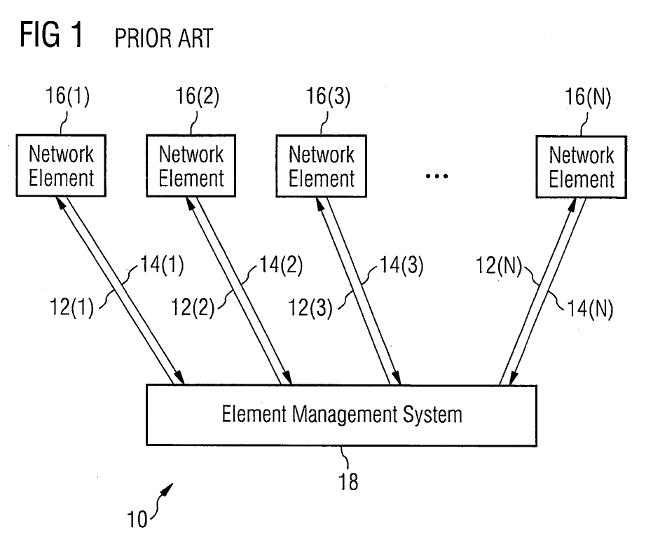

FIG. 1 shows a prior art schematic diagram of a communications system 10 having an EMS 18 using a one-to-one messaging 12, 14 scheme, commonly referred to as unicast, to communicate to a plurality of network elements 16. The EMS 18 manages the network elements 16 by sending SNMP request messages 12 including requests for performance monitoring, audits, inventory checks, and miscellaneous maintenance functions. For messages requiring a response the network elements 16 respond to the EMS 18 using an SNMP response message 14. For example, the EMS 18 may send an SNMP audit request 12(1) to the network element 16(1) and receive an SNMP audit response 14(2).

Referring now to FIG. 2, one embodiment of an exemplary method and apparatus of the present invention for managing the network elements 16 using a one-to-many messaging scheme, commonly referred to as multicast, is shown. The illustration includes the EMS 18 communicating to the network elements 16 via a broadcast channel 22(A). The broadcast channel 22(A) should be created by the EMS 18 and the network elements 16 may use IGMP to join a broadcast group 23(A) associated with the broadcast channel 22(A). This allows communication via the broadcast channel 22(A) from the EMS 18 to the network elements 16 that have joined the broadcast group 23(A) as well as between network elements 16 in the broadcast group 23(A). The term “broadcast” refers to sending a copy of a message to network elements 16 that have joined to the broadcast channel 22(A).

To issue a request, for example, the EMS 18 sends an SNMP request message 20(A) to the broadcast channel 22(A) facilitating a broadcast of the SNMP request message 24 to the network elements 16 that have joined the broadcast group 23(A). The network elements 16 receive the broadcasted SNMP request message 24 and process any part of the request related to the network element 16 which received the message. The result of the processed request may be stored in a buffer to be made available for later use.

The first network element 16(A1) is the master network element and creates an SNMP response message that includes the results from processing the SNMP request message 24(A1) and an identifier. The identifier indicates a subsequent network element to handle the response message. The master network element 16(A1) sends the SNMP response message 28(A1) to broadcast channel 22(A) which causes the SNMP response message 28(A1) to be broadcast to the network elements 16 that have joined the broadcast group 23(A). The SNMP response message 28 is disregarded by all network elements 16 not indicated by the identifier. In this example, the SNMP response message 28(A1) is meant for network element 16(A2); therefore, network elements 16(A1), and 16(A3) through 16(AN) disregard the response message 28(A1). For simplicity, a direct line between the network elements 16 versus through the broadcast channel 22(A) illustrates the message communication between the network elements 16.

Network element 16(A2) receives the SNMP response message 28(A1) and updates the message 28(A1) by adding to the message 28(A1) the results from processing the SNMP request message 24(A2). Additionally, the network element 16(A2) changes the identifier to the subsequent network element to handle the response. In this example the identifier is changed to indicate network element 16(A3). The updated SNMP response message 28(A2) is sent to network element 16(A3) using the broadcast technique as described above.

Network element 16(A3) receives the SNMP response message 28(A2) and handles the message as described above. This process continues until the last network element 16(AN) updates the SNMP response message and sends the updated SNMP response message 26(A) to the EMS 18. In this example the updated SNMP response message 26(A) contains the results for network elements 16(A1) through 16(AN).

Still referring to FIG. 2, to provide the communication order in which network element 16 communicate to each other, a network element 16 should maintain a previous identifier and a subsequent identifier. The previous identifier indicates a network element from which the network element 16 will receive a SNMP response message 28. The subsequent identifier indicates a network element in which to send a SNMP response message 28. The previous identifier may indicate that the previous element does not exist in which case the network element 16 is the first network element 16(A1) in the order. Likewise, the subsequent identifier may indicate that the subsequent element does not exist in which case the network element 16 is the last network element 16(AN) in the order.

In one embodiment the order is established via a load mechanism. Each network element 16 in the broadcast group communicates to the group how busy it is which is referred herein as “load”. Each network element 16 in turn receives the load of each network element 16 in the broadcast group 23(A) and compares its load to the loads of each element in the broadcast group 23(A). The network element 16 with the lowest load advantageously determines the communication order since it less busy than the other elements. Although a different element may determine the communication order. It is also advantageous for the order to be sorted in ascending order of load, such that, the first network element has the lowest load and the last network element has heaviest load. An ascending load order load sort would allow the network elements 16 with a heavier load time to process their request prior to having to add their request result to the SNMP result buffer to prevent a delay in message processing. However, the communication order may be in an order other than ascending load order.

As appreciated by those skilled in the art, methods other than the load mechanism to determine the communication order may be used. For example, the order in which the network elements 16 join the broadcast group 23(A) may be used. Another example, the IP address of the network elements 16 may be sorted to base the communication order. It may also be desired to periodically update the communication order in a broadcast group. This would be advantageous when using a load mechanism since the load of the network elements 16 changes.

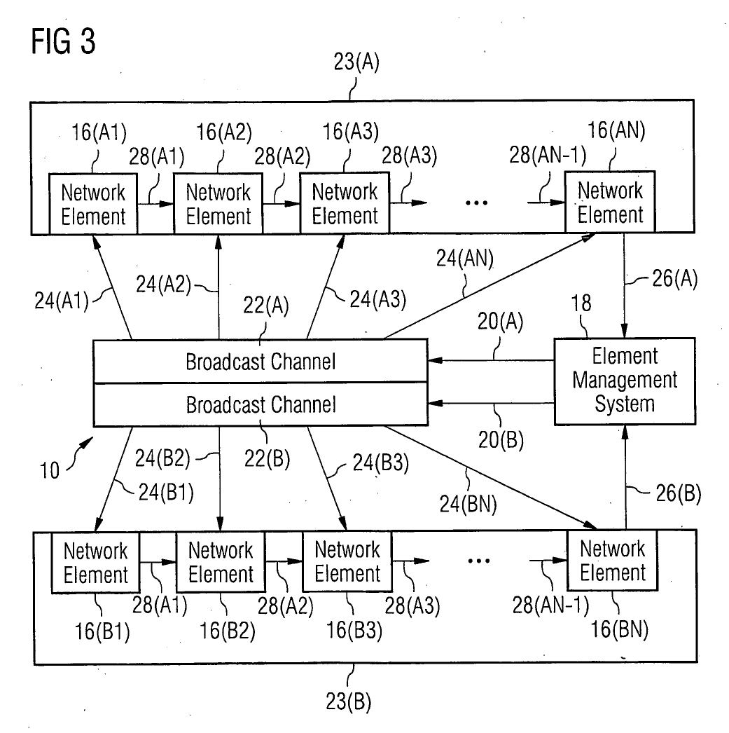

Referring now to FIG. 3, another embodiment of an exemplary method and apparatus of the present invention for managing the network elements 16 using a one-to-many messaging scheme is shown. As appreciated by those skilled in the art, it would be possible to have more than one broadcast channel 22. In the illustrated example, two broadcast channels 22(A) and 22(B) are provided.

Multiple broadcast channels 22 may be desirable for distributing the joining of the network elements 16 amongst multiple broadcast groups 23 thereby reducing the number of network elements 16 in the broadcast group 23. It also may be desirable to organize broadcast groups 23 by network element type, such as a broadcast group having only for MGs, another broadcast group having only ONUs, and the like.

When there are multiple broadcast channels, the EMS 18 keeps track the network elements 16 associated within the broadcast group 23. For example, network elements 16(A1) through 16(AN) have joined broadcast group 23(A), and network elements 16(B1) through 16(BN) have joined broadcast group 23(B). The EMS sends a request message 20(A) to manage one or more network elements 16(A1) through 16(AN) within broadcast group 23(A). Likewise, the EMS sends a request message 20(B) to manage one or more network elements 16(B1) through 16(BN) within broadcast group 23(B).

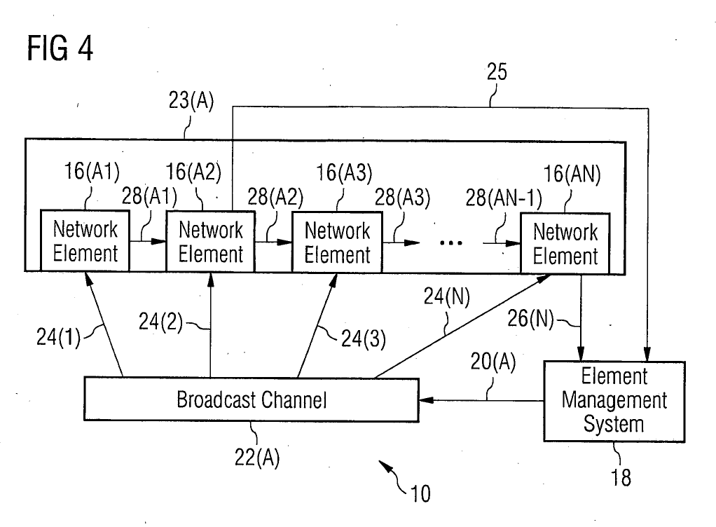

Referring now to FIG. 4, yet another embodiment of an exemplary method and apparatus of the present invention for managing the network elements 16 using a one-to-many messaging scheme and having multiple responses is provided. As would be appreciated by those skilled in the art the size SNMP response message 28 has a maximum size. The present invention allows a preemptive SMMP response message 25 to be sent to the EMS to avoid buffer overflow.

In one embodiment, the network element 16(A2) determines whether to send the preemptive SNMP response message 25 before it sends the SNMP response message to the subsequent network element 16(A3). If the network element 16(A2) determines the SNMP response message has reached a threshold, the SNMP response message becomes a preemptive SNMP response message 25 and is sent to the EMS 18. Additionally, the network element 16(A2) forms a SNMP response message from an empty response message and sends the SNMP response message 28(A2) to the subsequent network element 16(A3). The threshold may be a specific buffer size or a percentage of the maximum buffer size.

In another embodiment, the network element 16(A2) determines whether to send the preemptive SNMP response message 25 after it receives the response message. If the network element 16(A2) determines the received SNMP response message 28(A1) has reached a threshold, the response message becomes a preemptive SNMP response message 25 and is sent to the EMS 18. Additionally, the network element 16(A2) forms a SNMP response message from an empty response message, adds the processing result, and sends the SNMP response message 26(A2) to the subsequent network element 16(A3).

As recognized by those skilled in the art, other methods may be used to provide the preemptive SNMP response message 25. For example, the overflow condition could be reported to the EMS via a SNMP trap. Additionally, it would be recognized by those skilled in the art that although FIG. 4 shows one preemptive SNMP response message 25, there might be more than the one preemptive SNMP response message 25.

It may be desirable for the network element 16(A2) to have a timer element for waiting on receiving the SNMP response message 28(A1) from the previous network element 16(A1). The timer may be set to expire at a fixed time, a variable time, administered time. This would facilitate a continue processing mechanism in case the previous network element 16(A1) is taking to long, has some sort of failure, or any other reason that prevents the network element 16(A2) from receiving the SNMP response message 28(A1) by the timer expiration. In one embodiment, when the timer element expires without the network element 16(A2) having received the SNMP response message 28(A1) the network element 16(A2) may form a SNMP response message from an empty response message, add the processing result, and send the SNMP response message 26(A2) to the subsequent network element 16(A3). In another embodiment, when the timer element expires without the network element 16(A2) having received the SNMP response message 28(A1) the network element 16(A2) may form a preemptive SNMP response message from an empty response message, add the processing result, and send the SNMP preemptive response message 25 to the subsequent network element 16(A3). Additionally, the network element 16(A2) may form a SNMP response message from an empty response message and send the SNMP response message 26(A2) to the subsequent network element 16(A3)

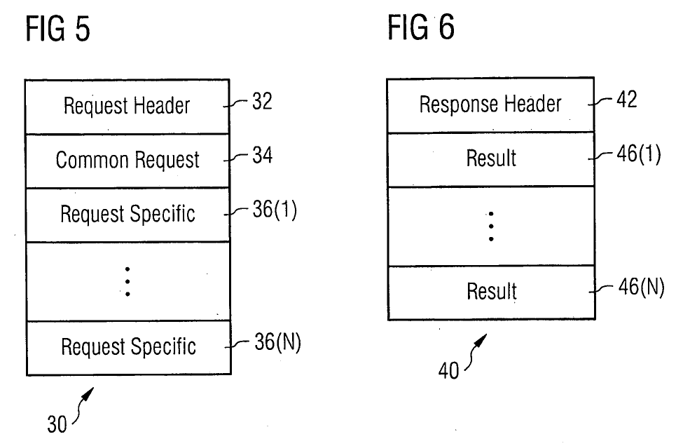

Referring now to FIGS. 4 and 5, an exemplary message layout of a SNMP request message 30 is shown. The SNMP request message 30 includes a request header 32, common requests field 34, and a request specific field 36 that is specific to a network element 34. The request header 32 provides the type of request such as a “get request”. The common request field 34 identifies the requests that are to be performed on all network elements 16 joined to the same broadcast group. The request specific field indicates a request specific to a network element. The number of request specific fields 36 is dependent on the maximum size of the SNMP message. As appreciated by those skilled in the art, other message formats may be used to facilitate the ability have request for more than one network element.

Referring now to FIG. 6, an exemplary message layout of a SNAP response message 40 is shown. The SNMP response message 40 includes a response header 42 and a result field 46. The response header 42 identifies the message as a response. The result 46 indicates a result specific to a network element. The number of result fields 46 is dependent on the maximum size of the SNMP message. As appreciated by those skilled in the art, other message formats may be used to facilitate the ability have results for more than one network element. An empty message layout is the SNMP response message layout with out the result 46 fields.

The invention may be embodied in many different forms and may be applied to many different types of networks, management systems, protocols, and protocol versions and should not be construed as limited to the embodiments set forth herein. Rather, these embodiments are provided so that this disclosure will be thorough and complete, and will fully convey the scope of the invention to those skilled in the art. Thus, the scope of the invention should be determined based upon the appended claims and their legal equivalents, rather than the specific embodiments described above.

1. A network element managed by a management system, comprising:
a join mechanism for joining the network element to a broadcast group;
a first receiver for receiving a management request from the management system via the broadcast group;
a result buffer that stores a result of the management request message;
a second receiver that receives a management response message from a previous network element; and
a sender for sending an updated management response message in response to receiving the management response message from the previous network element, the updated management response message sent to an entity selected from the group consisting of the management system and a subsequent network element.

2. The network-element according to claim 1, wherein the received management response message is an empty response message or includes a result of the management request for the previous network element.

3. The network element according to claim 2, wherein the updated management response message is formed by including the result from the result buffer to the received management response message.

4. The network element according to claim 1, wherein the updated management response message is formed from an empty response message.

5. The network element according to claim 4, wherein the updated management response message includes the result from the result buffer.

6. The network element according to claim 1, further comprising a preemptive response message sent to the management system.

7. The network element according to claim 1, further comprising a timer element adapted to expire after a maximum wait time to receive the management response message from the previous network element.

8. The network element according to claim 7, wherein in response to not receiving the management response message from the previous element prior to the timer element expiration:
a management response message including the result from the result buffer is sent to the management system, and
an empty response message is sent to the subsequent network element.

9. The network element according to claim 7, wherein in response to not receiving the management response message from the previous element prior to the timer element expiration a management response message including the result from the result buffer is sent to the subsequent network element.

10. The network element according to claim 1, further comprising a communication order mechanism that determines:
a master element, and
a order of communication between the network elements.

11. The network element according to claim 10, wherein the communication order mechanism is based on a load of a plurality elements joined in the broadcast group.

12. The network element according to 11, wherein the communication order mechanism is based on an ascending order of the load such that the busiest element is last in the communication order, thereby providing more time to process the management request message by the busiest element.

13. A method for managing a plurality of network elements via a management system, comprising:
joining the plurality of network element to a broadcast group associated with a broadcast channel, the plurality of network elements including a first network element and a second network element;
sending a management request message from the management system;
broadcasting the management request message to each of the elements in the broadcast group;
receiving the management request message by each of the elements in the broadcast group;
processing the management request message by each of network elements in response to receiving the management request message, wherein a result information is formed; and
sending a management response message from the first network element to the second network element.

14. The method according to claim 13, further comprising adding the result information for the first network element to the management response message prior to the sending of the management response message.

15. (canceled)

16. The method according to claim 13, further comprising:
receiving by the second network element a management response message;
analyzing the size of the response message plus the size of the result information for the second network element; and
sending to the management system the response message including the result information for the second network element information if the analyzed size of the response message plus the second network message has reached a threshold.

17-21. (canceled)

22. The method according to claim 14, further comprising:
receiving by the second network element a management response message; and
processing the management response message by:
analyzing the size of the response message plus the size of the result information for the second network element, and
sending to the management system the response message including the result information for the second network element information if the analyzed size of the response message plus the second network message has reached a threshold.

23. The method according to claim 22, wherein the processing the management response message further comprising sending a management response message formed from an empty response message to a third network element in the plurality of network elements, the management response message sent if the analyzed size of the response message plus the second network message has reached the threshold.

24. The method according to claim 22, further comprising adding an identifier for the second network element to the management response message.

25. The method according to claim 24,
wherein the management response message is sent by broadcasting the message to the plurality of network elements,
wherein each of the plurality of network elements examine the identifier in the management response message, and
wherein only the network element identified via the identifier processes the response message.

26. The method according to claim 14, further comprising adding an identifier for the second network element to the management response message.

27. The method according to claim 14, further comprising:
receiving by the second network element a management response message; and
processing the management response message by:
analyzing the size of the response message plus the size of the result information for the second network element, and
sending to the management system the response message including the result information for the second network element information if the analyzed size of the response message plus the second network message is less than a threshold and when the second network element is the last network element in the broadcast group to process the management response.
